(19) United States
(12) Patent Application Publication
(10) Pub. No.: US 2003/0161170 A1
(43) Pub. Date: Aug. 28, 2003

(54) Adapter with a DC electric power output and an AC electric power output

(76) Inventor: Anthony Lee, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/063,774

(22) Filed: May 11, 2002

(30) Foreign Application Priority Data
Feb. 27, 2002 (TW) 091103693

(51) Int. Cl. H02M 1/00

(52) U.S. Cl. 363/146

(57) ABSTRACT

An adapter generates a DC electric power output and an AC electric power output according to an AC electric power input. The adapter has a first housing, at least a plug positioned on the first housing for receiving the AC electric power input, a first socket positioned on the first housing being electrically connected to the plug for outputting the AC electric power output, a second housing movably connected to the first housing, a transformer electrically connected to the plug for converting the AC electric power input into the DC electric power output, and a second socket positioned on the second housing being electrically connected to the transformer for outputting the DC electric power output. The second housing can pivot on the first housing according to an axle, and the first socket is covered by the second housing when the second housing is rotated to a predetermined position.

### BACKGROUND OF INVENTION

1. Field of the Invention

The present invention relates to an adapter, and more particularly, to an adapter which can receive AC electric power from different types of sockets and output DC electric power and AC electric power simultaneously.

2. Description of the Prior Art

In modern society, electric appliances have become necessities of life. However, most electric appliances must be equipped with proper plugs to adapt to specific sockets adopted by different nations. For example, an electric appliance having a plug with two protruding pins must be used in a region where the socket with two receiving holes is adopted. If the plug does not match up with the specific socket, the electric appliance cannot work for lack of electric power. For people who often travel around different regions, a popular problem is how to use an electric appliance with one plug in different nations. Because the socket specifications are different among many nations, the electric appliance with only one plug cannot be widely used in different nations. That is, the plug is not compatible with many different sockets for receiving electric power successfully. For example, a socket specification (type A) adopted in Japan is different from that (type B) adopted in Germany. Because different nations have different socket specifications, it is difficult to use the same electric appliance in different nations. A U.S. Pat. No. 5,791,921 “Easily Operable Universal Adapter”, therefore, discloses an adapter that can receive AC electric power provided by different sockets and output the AC electric power through a special output socket. The output socket is compatible with many socket specifications so that many electric appliances can acquire the AC electric power after being electrically connected to the special output socket. The prior art adapter mentioned above is described briefly as follows.

Please refer to FIG. 1 to FIG. 5. FIG. 1 is a first perspective diagram of a prior art adapter 10. FIG. 2 is a second perspective diagram of the adapter 10 shown in FIG. 1. FIG. 3 is a diagram displaying a first shape of the adapter 10 shown in FIG. 1. FIG. 4 is a diagram displaying a second shape of the adapter 10 shown in FIG. 1. FIG. 5 is a diagram displaying a third shape of the adapter 10 shown in FIG. 1. As shown in FIG. 1 and FIG. 2, the adapter 10 has a housing 12, a plurality of plugs 14, 16, 18, an output socket 19, a plurality of buttons 20, 22, and a plurality of plug slots 24, 26, 28. The plugs 14, 16, 18 are movable or rotatable inside the plug slots 24, 26, 28 respectively, and the buttons 20, 22 installed on the sides of the adapter 10 are used for controlling relative movements between the plugs 16, 18 and the corresponding plug slots 26, 28. Because the buttons 20, 22 are installed on both sides of the adapter 10, a user can push the buttons 20, 22 conveniently. The adapter 10 uses the plugs 14, 16, 18 adapted to different input sockets for receiving desired AC electric power provided by the input sockets, and the received AC electric power is outputted from the output socket 19. The plugs 14, 16, 18 are individually compatible with different plug specifications to have different shapes of protruding pins 30, 32, 34. As shown in FIG. 3, the plug 14, for example, is a type B plug adopted in Germany. The protruding pins 30 are cylinders and are parallel with each other. The protruding pins 30 of the plug 14 will emerge out of the plug slot 24 and the housing 12 after the plug 14 is rotated properly. Therefore, the protruding pins 30 are used to plug into a corresponding type B socket, and the AC electric power outputted through the output socket 19 can drive electric appliances that are correctly connected to the output socket 19. As shown in FIG. 4, the plug 16, for example, is a type D plug adopted in England, and has protruding pins 32a, 32b, 32c whose shapes are bars. The protruding pin 32a is parallel with the protruding pin 32b, and the protruding pin 32c is perpendicular to the protruding pins 32a, 32b when a cross-section of the protruding pins 32a, 32b, 32c is considered. The protruding pins 32a, 32b of the plug 16 will emerge out of the plug slot 26 and the housing 12 after the button 20 associated with the plug 16 is appropriately pushed to make the plug 16 slide. In addition, the protruding pin 32c can be rotated to emerge out of the housing 12. Therefore, the protruding pins 32a, 32b, 32c are compatible with the corresponding type D socket, and the AC electric power outputted through the output socket 19 can drive electric appliances that are correctly connected to the output socket 19. Similarly, the plug 18, as shown in FIG. 5, is a type E plug which is adopted in Australia. The shape of the protruding pins 34 are bars, and the cross-section of the protruding pins 34 reveals that the protruding pins 34 are not perpendicular to each other. In addition, each of the protruding pins 34 is capable of being rotated to generate different angle relations between the protruding pins 34 for matching up with other sockets. For example, the plug used in Taiwan is a type A plug, the cross-section of the protruding pins shows that the protruding pins are rotated to be parallel with each other. In other words, the protruding pins 34, then, are rotated according to different requirements. The protruding pins 34 of the plug 18 will emerge out of the plug slot 28 and the housing 12 after the button 22 is properly pushed to slide the plug 18. Therefore, the protruding pin 34 is compatible with type E sockets, and the AC electric power outputted through the output socket 19 can drive electric appliances that are correctly connected to the output socket 19.

Small-size electric appliances such as a personal digital assistant, a digital camera, and so forth are popular among consumers. Those small-size electric appliances generally use DC electric power to provide necessary operating voltages. In order to be used and carried conveniently, the small-size electric appliances generally use rechargeable batteries (Li⁺-ion battery for example) to provide the required operating voltages. However, rechargeable batteries inevitably have a limited duration to output a stable operating voltage, and electric appliances shut down when the rechargeable batteries are exhausted. Therefore, the small-size electric appliance usually has a DC power input port for receiving DC power generated from an outer power supply. The DC power input port takes the place of the rechargeable battery to provide the small-size electric appliance with the adequate operating voltage. As mentioned above, the prior art adapter 10, however, is only capable of transferring the AC electric power from one socket specification to another socket specification. Although the adapter 10 can bridge the output socket 19 and different sockets adopted in many nations, the adapter 10 cannot output DC electric power to drive the electric appliances which require DC operating voltages. Therefore, the prior art adapter 10 is useless when users have electric appliances that require DC operating voltages.

### SUMMARY OF INVENTION

It is therefore a primary objective of the claimed invention to provide an adapter with a power transformer to solve the above mentioned problem.

Briefly, the claimed invention provides an adapter for outputting a direct current (DC) electric power output and an alternating current (AC) electric power output according to an AC electric power input. The adapter comprises a first housing, at least a plug positioned on the first housing comprising at least two protruding pins for receiving the AC electric power input, a first socket positioned on the first housing comprising at least two receiving holes for outputting the AC electric power output to the plug, a second housing movably connected to the first housing, a power transformer electrically connected to the plug for transforming the AC electric power input into the DC electric power output, and a second socket positioned on the second housing. The second socket is electrically connected to the power transformer for outputting the DC electric power output.

It is an advantage of the claimed invention that the claimed adapter can output both AC electric power and DC electric power so that the adapter according to the claimed invention is suitable for any electric appliance. In addition, the claimed adapter has two housings that are connected through an axle, and two sockets positioned on each of the two housings for outputting either AC electric power or DC electric power. Therefore, a user can fold up the claimed adapter to make the adapter more compact when the user needs only one type of electric power.

These and other objectives of the claimed invention will no doubt become obvious to those of ordinary skill in the art after reading the following detailed description of the preferred embodiment which is illustrated in the various figures and drawings.

### BRIEF DESCRIPTION OF DRAWINGS

FIG. 1 is a first perspective diagram of a prior art adapter.

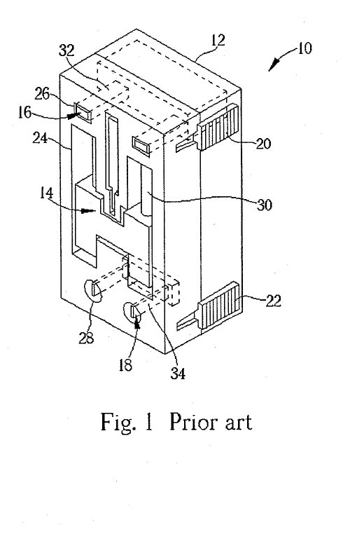

FIG. 2 is a second perspective diagram of the adapter shown in FIG. 1.

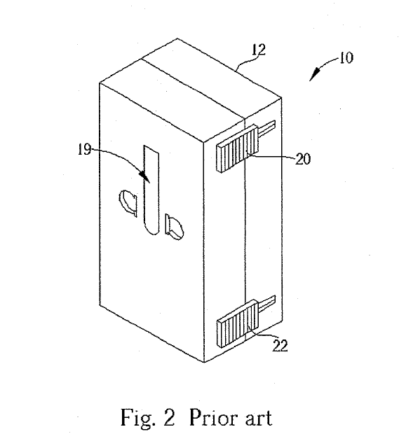

FIG. 3 is a diagram displaying a first shape of the adapter shown in FIG. 1.

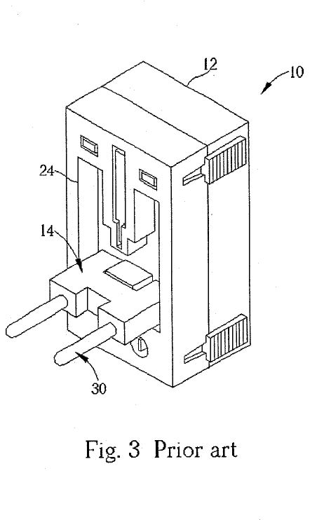

FIG. 4 is a diagram displaying a second shape of the adapter shown in FIG. 1.

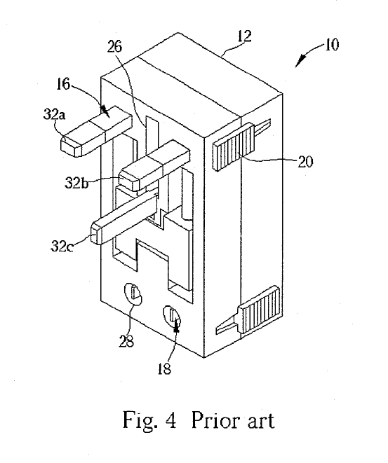

FIG. 5 is a diagram displaying a third shape of the adapter shown in FIG. 1.

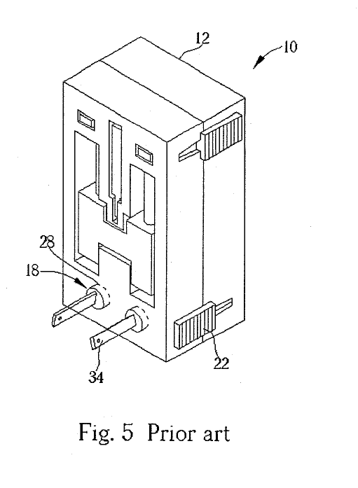

FIG. 6 is a first perspective diagram of an adapter according to the present invention.

FIG. 7 is a second perspective diagram of the adapter shown in FIG. 6.

FIG. 8 is a power transmission diagram of the adapter shown in FIG. 6.

### DETAILED DESCRIPTION

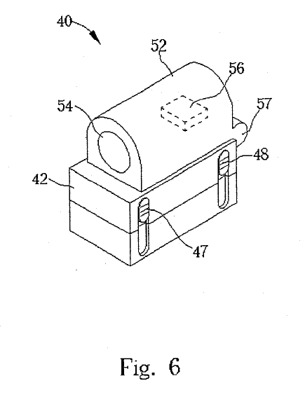

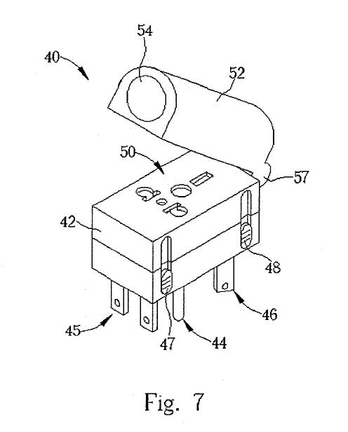

Please refer to FIG. 6 and FIG. 7. FIG. 6 is a first perspective diagram of an adapter 40 according to the present invention, and FIG. 7 is a second perspective diagram of the adapter 40 shown in FIG. 6. The adapter 40 is based on the prior art adapter 10 to have a first housing 42, a plurality of plugs 44, 45, 46, a plurality of buttons 47, 48, a first socket 50, a second housing 52, a second socket 54, a power transformer 56, and an axle 57. The first housing 42, the plugs 44, 45, 46, the buttons 47, 48, and the first socket 50 are identical to the elements of the same names disclosed in the prior art adapter 10. As mentioned before, the plugs 44, 45, 46 are compatible with different input sockets for receiving AC electric power. The buttons 47, 48 are used to control relative movements between the plugs 45, 46 and the corresponding plug slots (not shown). In the end, the AC electric power provided by the output sockets is transmitted to the first socket 50 through the plugs 44, 45, 46. Therefore, the electric appliances can use a proper plug that is compatible with the first socket 50 but the input socket to acquire the AC electric power. A U.S. Pat. No. 5,791,921 “Easily Operable Universal Adapter” has described the detailed operation and the related structure.

The kernel improvement of the present invention is that a second socket 54 that can output DC electric power is combined with the prior art adapter 10. The second socket 54 is positioned on the second housing 52. The second housing 52 is capable of pivoting on the first housing 42 with the help of the axle 57. Therefore, when the second housing 52 is rotated to a predetermined position (FIG. 6), the first socket 50 used for outputting AC electric power is covered by the second housing 52. The present invention discloses a power transformer 56 installed inside the second housing 52, and the power transformer 56 is electrically connected to the plugs 44, 45, 46 for converting the AC electric power into DC electric power. For example, AC electric power with 110 volts is converted into DC electric power with 12 volts. The second socket 54 such as a cigar socket or other types of sockets is used for outputting the DC electric power for providing the electric appliances that use DC operating voltages with the required DC electric power.

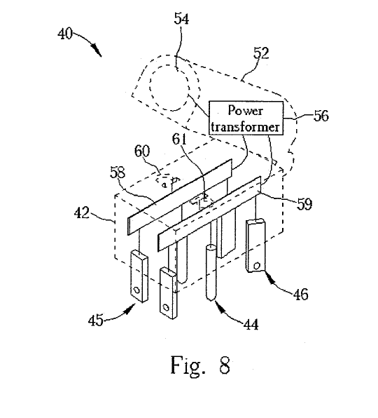

Please refer to FIG. 8, which is a power transmission diagram of the adapter 40 shown in FIG. 6. The adapter 40 further has two metal sheets 58, 59 installed inside the first housing 42. The metal sheets 58, 59 are electrically connected to the plugs 44, 45, 46 for transferring the AC electric power received by the plugs 44, 45, 46. Each of the plugs 44, 45, 46 has two protruding pins. One protruding pin is electrically connected to the metal sheet 58, and another protruding pin is electrically connected to the metal sheet 59. In addition, the first socket 50 has two receiving holes 60, 61 for outputting the AC electric power to the electric appliances. The receiving hole 60 is electrically connected to the metal sheet 59, and the receiving hole 61 is electrically connected to the metal sheet 59. Therefore, the AC electric power outputted by different types of sockets is received by the plugs 44, 45, 46, and is transferred to the first socket 50 via the metal sheets 58, 59. Furthermore, the metal sheets 58, 59 are electrically connected to the power transformer 56 so that the power transformer 56 will convert the AC electric power into DC electric power simultaneously. The DC electric power generated by the power transformer 56 is outputted through the second socket 54. Please take notice of the present embodiment-that the power transformer 56 is installed inside the second housing 52. But, if the power transformer 56 is installed inside the first housing 42, the adapter 40 according to the present invention can achieve the same objective of converting AC electric power into DC electric power as well.

In contrast to the prior art adapter, the adapter according to the present invention uses a power transformer to convert AC electric power into DC electric power, and outputs the DC electric power through a predetermined socket. In addition, the adapter according to the present invention is further based on the prior art adapter to output AC electric power by bridging two different socket specifications. Therefore, the adapter according to the present invention can output the AC electric power and the DC electric power at the same time so that the claimed adapter is suitable for an electric appliance whose operating voltage required AC electric power or DC electric power. That is, the function of the prior art adapter is improved to give users a convenient tool. Furthermore, the adapter according to the present invention has a first housing and a second housing, and the second housing can pivot on the first housing according to an axle. When the user does not need the socket on the first housing, the user can rotate the second housing to shelter the socket on the first housing so that the second housing is on top of the first housing. Therefore, the length of the adapter according to the present invention is reduced to make the adapter more compact. In other words, the user can fold up the claimed adapter to place or carry the claimed adapter conveniently.

Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An adapter for outputting a direct current (DC) electric power output and an alternating current (AC) electric power output according to an AC electric power input, the adapter comprising:
a first housing;
at least a plug positioned on the first housing comprising at least two protruding pins for receiving the AC electric power input;
a first socket positioned on the first housing comprising at least two receiving holes, the first socket being electrically connected to the plug for outputting the AC electric power output to the plug;
a second housing movably connected to the first housing;
a power transformer electrically connected to the plug for transforming the AC electric power input into the DC electric power output; and
a second socket positioned on the second housing, the second socket being electrically connected to the power transformer for outputting the DC electric power output.

2. The adapter of claim 1 further comprising an axle for hinging the first housing and the second housing so that the second housing is capable of pivoting on the axle.

3. The adapter of claim 2 wherein when the second housing is rotated to a predetermined position, the second housing shelters the first socket positioned on first housing from being used.

4. The adapter of claim 1 wherein the second socket is a cigar socket.

5. The adapter of claim 1 wherein the power transformer is positioned inside the second housing.

6. The adapter of claim 1 wherein the first housing comprises a plug slot, and the plug is movably installed inside the plug slot so that the plug can be pushed to pivot on the plug slot for making the protruding pins emerge out of the first housing.

7. The adapter of claim 1 wherein the first housing comprises a plug slot, and the plug is movably installed inside the plug slot so that the plug can be pushed to slide along the plug slot for making the protruding pins emerge out of the first housing.

8. The adapter of claim 1 further comprising two metal sheets individually connected to the corresponding protruding pins for transferring the AC electric power input to the power transformer.

9. The adapter of claim 1 further comprising a plurality of plugs, each of the plugs used for receiving a corresponding AC electric power input which is provided by a corresponding input socket wherein the plugs with different specifications are adapted to proper input sockets individually for successfully receiving corresponding AC electric power inputs.
